(19) United States
(12) Patent Application Publication
(10) Pub. No.: US 2013/0138283 A1
(43) Pub. Date: May 30, 2013

(54) HYBRID POWER TRAIN FOR VEHICLE AND METHOD FOR CONTROLLING THE SAME

(71) Applicant: In Ho Cho, Hwaseong (KR)

(72) Inventor: In Ho Cho, Hwaseong (KR)

(73) Assignee: HYUNDAI MOTOR COMPANY, Seoul (KR)

(21) Appl. No.: 13/540,918

(22) Filed: Jul. 3, 2012

(30) Foreign Application Priority Data
Nov. 28, 2011 (KR) 10-2011-0125044

(51) Int. Cl. B60W 20/00; B60W 10/02; B60K 6/20; B60W 10/08

(52) U.S. Cl. 701/22; 74/665 A; 903/930; 180/65.265; 180/65.25

(57) ABSTRACT

Disclosed is a hybrid power train for a vehicle that includes an engine driving shaft and a transmission driving shaft that are disposed concentrically a first motor generator in which a first rotor is connected to the engine driving shaft through a first clutch; a second motor generator in which a second rotor is connected to the first motor generator through a second clutch. The second rotor is also connected with the transmission driving shaft, and a torsion damper is disposed between the first clutch and an engine.

### CROSS-REFERENCE TO RELATED APPLICATION

This application claims under 35 U.S.C. §119(a) the benefit of Korean Patent Application No. 10-2011-0125044 filed on Nov. 28, 2011, the entire contents of which are incorporated herein by reference.

### BACKGROUND

(a) Technical Field

The present invention relates to a hybrid power train for a vehicle, and more particularly, to a power train for a hybrid vehicle and a method for controlling the same that drives a vehicle by combining an engine as an internal combustion engine and an electric motor.

(b) Background Art

A full type parallel hybrid power train is a vehicle that can run on just the engine, just an electrical power train, or a combination of both. Referring to FIGS. 1 and 2, in a typical hard (full) type parallel hybrid power train, a motor generator 500 generating driving force of a vehicle is connected to an input shaft of a transmission 502, a clutch 506 is provided between an engine 504 and the motor generator 500 to control the engine 504 and the motor generator 500, and a hybrid starter & generator (HSG) 508 is connected to an additional shaft through a belt 510 in the engine 504.

The HSG serves to generate stopping torque (1) for improving noise, vibration and harshness (NVH) performance and (2) charging a battery in an idle state when an engine turns on. The HSG also serves as a means for switching the vehicle into hybrid mode by connecting the engine to the clutch 506 after the engine has been started while the clutch 506 is disengaged while driving in the vehicle in an electric vehicle mode through the motor generator 500.

However, as described above, the HSG 508 is connected to the belt 510 and a pulley in order to transfer power as shown in FIG. 1. The belt 510 is exposed to severe operating conditions due to frequent starting and stopping operations of the engine, thus the durability of the belt cannot be sufficiently ensured, and as a result, frequent replacement of this belt is required.

Matters described as the background art are just to improve the background of the present invention, but it should not be understood that the matters correspond to the related art which has been already known to those skilled in the art.

### SUMMARY OF THE DISCLOSURE

The present invention has been made in an effort to provide a hybrid power train for a vehicle and a method for controlling the same that can implement more variations in driving and charging controls as well as all operating modes of a hard type parallel hybrid power train without requiring a belt.

An exemplary embodiment of the present invention provides a hybrid power train for a vehicle including: an engine driving shaft and a transmission driving shaft that are disposed concentrically; a first motor generator in which a rotor is connected to the engine driving shaft through a first clutch; a second motor generator in which the rotor is connected to the first motor generator through a second clutch and the rotor is connected to the transmission driving shaft; and a torsion damper provided between the first clutch and an engine, and a method for controlling the same.

The hybrid power train may further include a battery that is connected with the first motor generator and the second motor generator to supply power to the first and second motor generator. Furthermore, in some exemplary embodiments of the present invention, the first motor generator and the second motor generator may have different driving capacities.

The hybrid power train may further include a control unit that is configured to control a plurality of modes of the first motor generator, the second motor generator, the first clutch, and the second clutch. The control unit may be configured to drive the vehicle via a single torque of the second motor generator or the first motor generator or joint torque of the first motor generator and the second motor generator in an electric vehicle mode. Additionally, the control unit may charge the battery by using the engine and the first motor generator in the charging mode, however, the first motor generator may control the constant torque and the reverse torque to be applied to the engine when the engine turns on/off.

In the hybrid mode, the control unit may control the vehicle to be driven by the joint torque of the engine and the second motor generator or the joint torque of the engine and the first motor generator and the second motor generator. Furthermore, the control unit may connect the second motor generator and the engine after revolutions per minute (RPMs) of the engine are synchronized with the RPMs of the first motor generator in the hybrid mode.

Meanwhile, in a method for controlling the hybrid power train for a vehicle, driving force is transferred to the transmission driving shaft by the single torque of the first motor generator, the single torque of the second motor generator, or the joint torque of the first and second motor generators in the electric vehicle mode and the diving force is transferred to the transmission driving shaft by the joint torque of the engine and the second motor generator or the joint torque of the engine and the first and second motor generators in the hybrid mode.

In the charging mode, a battery may be charged by using the engine and the first motor generator, however, the first motor generator may apply constant torque and reverse torque to the engine when the engine turns on/off as well. Furthermore, In the hybrid mode, the engine and the second motor generator may be connected with each other after rpm of the engine is synchronized with the second motor generator by the first motor generator.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing a configuration in which an HSG is connected to a crankshaft of an engine through a belt in order to configure a hard type parallel hybrid power train in a conventional design;

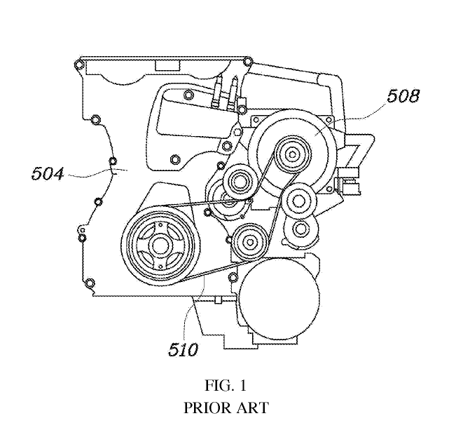

FIG. 2 is a conceptual diagram of the hard type parallel hybrid power train in the conventional art;

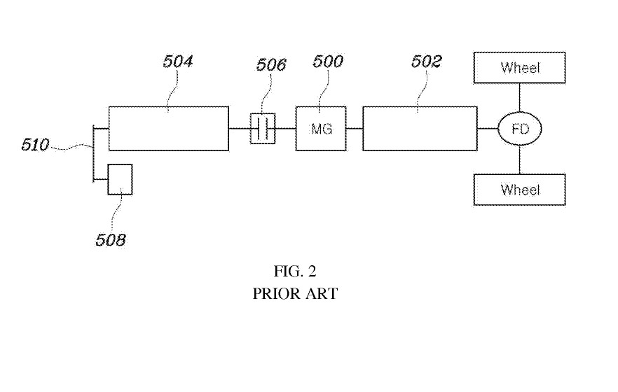

FIG. 3 is a conceptual diagram of a hybrid power train for a vehicle according to an exemplary embodiment of the present invention; and

FIG. 4 is a configuration diagram of primary parts of the hybrid power train for a vehicle shown in FIG. 3.

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

Hereinafter, a hybrid power train for a vehicle and a method for controlling the same according to exemplary embodiments of the present invention will be described with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

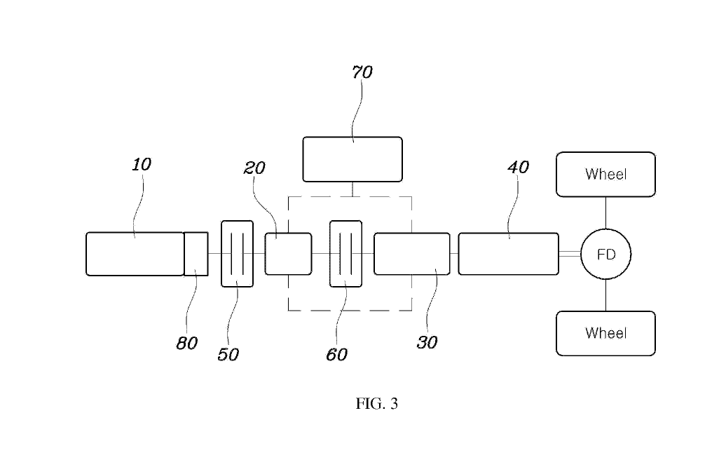

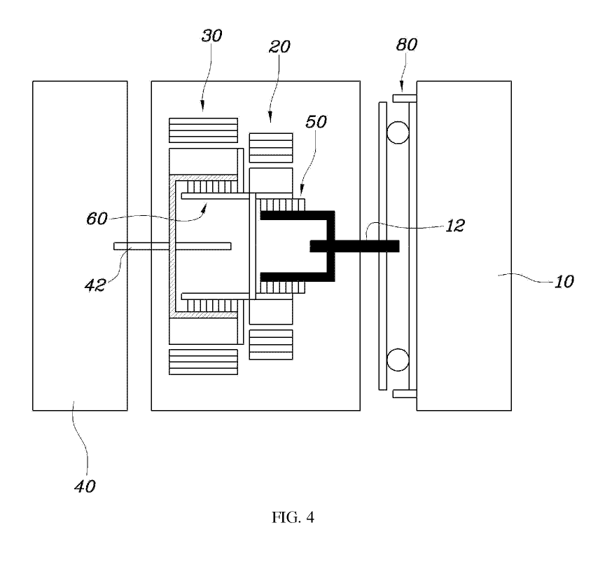

FIG. 3 is a conceptual diagram of a hybrid power train for a vehicle according to an exemplary embodiment of the present invention and FIG. 4 is a configuration diagram of primary parts of the hybrid power train for a vehicle shown in FIG. 3.

The hybrid power train for a vehicle according to the exemplary embodiment of the present invention includes an engine driving shaft 12 and a transmission driving shaft 42 that are disposed concentrically, and a first motor generator 20 in which a first rotor is connected to the engine driving shaft 12 through a first clutch 50. The hybrid power train of the exemplary embodiment of the present invention also includes a second motor generator 30. A second rotor within the second motor generator 30 is connected to the first motor generator 20 through a second clutch 60. Additionally, the second rotor is also connected with the transmission driving shaft 42 as well. Also, a torsion damper 80 is provided between the first clutch 50 and an engine 10.

In the exemplary embodiment of the present invention, a rotational shaft of the first motor generator 20 that replaces the HSG in the related art is not configured separately from the engine driving shaft 12 but may be integrally provided on a concentric shaft, and as a result, there is no need for a belt like in the conventional art.

Herein, the engine driving shaft 12 may be the crankshaft of the engine and the transmission driving shaft 42 may be a transmission input shaft. In addition, the first motor generator 20 and the engine 10 may be bound to each other through the first clutch 50 and the first motor generator 20 and the second motor generator 30 may be bound to each other through the second clutch 60.

Since the belt utilized in the conventional design has been removed in this power train system, the problems associated with replacement costs and operational stability are sufficiently rectified. Furthermore, the revolutions per minute (RPMs) of the engine can be controlled via a motor, and as a result, noise/vibration/harshness (NVH) is remarkably reduced during start up and shut down due to constant torque or reverse torque. Finally, the engine can operate as a generator, thereby implanting optimal fuel efficiency.

The exemplary embodiment of the present invention may further include a battery 70 that is connected with both the first motor generator 20 and the second motor generator 30 to supply power to the first and second motor generators respectively and may further include a control unit that controls modes of the first motor generator 20, the second motor generator 30, the first clutch 50, and the second clutch 60.

The battery is connected with the first motor generator 20 and the second motor generator 30 to supply power to the motors or on the contrary, the battery may be charged through the motors either respectively or in combination. In addition, in this configuration, the control unit may be configured to control the modes of the first motor generator 20, the second motor generator 30, the first clutch 50, and the second clutch 60 to control the motors to apply or restore the torque and even to control the clutch to be engaged or disengaged. The first and second clutches may be, for example, a friction wet clutch.

Meanwhile, the first motor generator 20 and the second motor generator 30 may be configured to have different driving capacities. Therefore, the total three limit torques and power generatable amounts are achieved through joining or separating two motors.

More specifically, the control unit may be configured to drive the vehicle via the single torque of the second motor generator 30 or the first motor generator 20 or the joint torque of the first motor generator 20 and the second motor generator 30 in an electric vehicle mode.

In addition, the control unit may also be configured to charge the battery via the engine 10 and the first motor generator 20 in the charging mode, however, the first motor generator 20 controls the constant torque and the reverse torque to be applied to the engine when the engine 10 turns on and off.

Further, in the hybrid mode, the control unit controls the vehicle to be driven via a joint torque from the engine 10 and the second motor generator 30 or a joint torque from the engine 10 and the first motor generator 20 and the second motor generator 30. In this case, the control unit connects the engine 10 with the second motor generator 30 after the revolutions per minute (RPMs) of the engine 10 are synchronized by the first motor generator 20 in the hybrid mode. That is, in the electric vehicle (EV) mode, driving force may be generated via a multistage process through joint torque of the first motor generator 20, the second motor generator 30, and/or the joint torques of the first and second motor generators 20 and 30.

In addition, in the hybrid (HEV) mode, driving force may be generated by joint torque of the second motor generator 30, and the first and second motor generators 20 and 30 together with the engine 10. The control unit connects via the second clutch 60 the second motor generator 30 to the engine 10 after the RPMs of the engine 10 are synchronized by the first motor generator 20 to implement optimal performance and driving feeling in the hybrid mode.

Meanwhile, the engine 10 is used for charging the battery 70 through the first motor generator 20 in an idle start state to provide optimal efficiency and fuel efficiency. Simultaneously, the second motor generator 30 enables the vehicle to be driven in the electric vehicle mode. Further, the first motor generator 20 is controlled to apply the constant torque and the reverse torque to the engine 10 when the engine 10 turns on and off to prevent impact and noise caused from starting up the engine. In addition, a torsion damper 80 is provided between the first clutch 50 and the engine 10 to dampen any impact which may be generated therebetween.

In a method for controlling the hybrid power train for a vehicle, driving force is transferred to the transmission driving shaft by the single torque of the first motor generator, the single torque of the second motor generator, or a joint torque from the first and second motor generators in the electric vehicle mode. Alternatively, the diving force is transferred to the transmission driving shaft by the joint torque of the engine and the second motor generator or the joint torque of the engine and the first and second motor generators in the hybrid mode.

In the charging mode, the battery is charged via the engine and the first motor generator, however, the first motor generator may apply a constant torque and a reverse torque to the engine when the engine turns on and off.

In the hybrid mode, the engine and the second motor generator may be connected with each other after the RPMs of the engine are synchronized with the second motor generator by the first motor generator.

According to a hybrid power train for a vehicle having the above-mentioned structure and a method for controlling the same, all operating modes and additional operating modes of the full parallel hybrid power train in the conventional art can be implemented, components such as a belt, a pulley, an idler, and a tensioner are not required, and as a result, manufacturing costs are saved and a more compact power train can be configured while durability issued caused by the belt in a conventional full parallel power train.

Furthermore, the control logic of the present invention may be embodied as non-transitory computer readable media on a computer readable medium containing executable program instructions executed by the controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. A hybrid power train for a vehicle, comprising:
an engine driving shaft and a transmission driving shaft disposed concentrically;
a first motor generator in which a first rotor is connected to the engine driving shaft through a first clutch;
a second motor generator in which a second rotor is connected to the first motor generator through a second clutch and the second rotor is connected with the transmission driving shaft; and
a torsion damper disposed between the first clutch and an engine.

2. The hybrid power train for a vehicle of claim 1, further comprising a battery connected to both the first motor generator and the second motor generator to supply power to the first motor generator and the second motor generator.

3. The hybrid power train for a vehicle of claim 1, wherein the first motor generator and the second motor generator have different driving capacities.

4. The hybrid power train for a vehicle of claim 1, further comprising a control unit configured to control modes of the first motor generator, the second motor generator, the first clutch, and the second clutch.

5. The hybrid power train for a vehicle of claim 4, wherein the control unit control the vehicle to be driven by a single torque of the second motor generator or the first motor generator, or a joint torque of the first motor generator and the second motor generator in an electric vehicle mode.

6. The hybrid power train for a vehicle of claim 4, wherein the control unit charges the battery via the engine and the first motor generator in a charging mode, wherein the first motor generator controls a constant torque and a reverse torque to be applied to the engine when the engine turns on and off.

7. The hybrid power train for a vehicle of claim 4, wherein in a hybrid mode, the control unit controls the vehicle to be driven by the joint torque of the engine and the second motor generator or the joint torque of the engine and the first motor generator and the second motor generator.

8. The hybrid power train for a vehicle of claim 7, wherein the control unit connects the second motor generator with the engine after RPMs of the engine are synchronized by the second clutch and the first motor generator in the hybrid mode.

9. A method for controlling the hybrid power train for a vehicle of claim 1, wherein a driving force is transferred to the transmission driving shaft by a single torque of the first motor generator, a single torque of the second motor generator, or a joint torque of the first and second motor generators in an electric vehicle mode and a diving force is transferred to the transmission driving shaft via the joint torque of the engine and the second motor generator or joint torque of the engine and the first and second motor generators in a hybrid mode.

10. The method for controlling the hybrid power train for a vehicle of claim 9, wherein in the charging mode, a battery is charged via the engine and the first motor generator, wherein the first motor generator applies a constant torque and a reverse torque to the engine when the engine turns on and off.

11. The method for controlling the hybrid power train for a vehicle of claim 9, wherein in the hybrid mode, the engine and the second motor generator re connected with each other after RPMs of the engine are synchronized with the second motor generator by the first motor generator.
